(19) United States
(12) Patent Application Publication
(10) Pub. No.: US 2025/0135713 A1
(43) Pub. Date: May 1, 2025

(54) METHOD FOR PREPARING DECORATIVE MATERIAL AND APPLICATION THEREOF

(71) Applicants: Peitong CHAO, Tainan City Taiwan (CN); FOSHAN SHUNDE PURETE MECHANICAL CO., LTD., Foshan City, Guangdong (CN)

(72) Inventor: Peitong CHAO, Tainan City Taiwan (CN)

(73) Assignees: Peitong CHAO, Tainan City Taiwan (CN); FOSHAN SHUNDE PURETE MECHANICAL CO., LTD., Foshan City, Guangdong (CN)

(21) Appl. No.: 18/856,288

(22) PCT Filed: Apr. 12, 2023
(86) PCT No.: PCT/CN2023/087871

§ 371 Date: Oct. 11, 2024

(30) Foreign Application Priority Data
Apr. 13, 2022 (CN) 202210394538.X

(51) Int. Cl. B29C 59/02; B29C 59/00; B29K 101/12; B29K 105/16; B29L 31/00

(52) U.S. Cl. CPC B29C 59/02; B29C 59/002; B29K 2101/12; B29K 2105/16; B29L 2031/732; B29L 2031/776

(57) ABSTRACT

The present disclosure relates to a method for preparing a decorative material and application thereof. The method includes using a main base material for material distribution to form a main base material layer, and distributing a grain base material on an upper surface of the main base material layer to form a grain pattern, so as to obtain a blank, wherein the main base material is a thermoplastic material; performing hot-press molding on the blank to obtain a semi-finished product embedded with the grain base material on a surface; and removing the grain base material on the surface of the semi-finished product to obtain the decorative material.

### CROSS-REFERENCE TO RELATED APPLICATION

This application is a national stage filing under 35 U.S.C. § 371 of International Patent Application No. PCT/CN2023/087871, filed Apr. 12, 2023, which claims priority to Chinese Patent Application No. 202210394538.X, filed Apr. 13, 2022. The contents of these applications are incorporated herein by reference in their entirety.

### TECHNICAL FIELD

The present disclosure belongs to the technical field of decorative materials, and more particularly, relates to a method for preparing a decorative material and application thereof.

### BACKGROUND

A current plastic floor printing film is mainly made by gravure printing, and it is necessary to make a film before printing. A protective layer is made of the same material on a surface to improve a wear-resistant effect and avoid a printed layer from being worn off. A thickness of a wear-resistant layer is generally used as a basis to distinguish a commercial product from a household product. In order to improve a surface effect of floor, two digital printers are connected in the prior art. One printer prints a pattern, and after making a UV protective coating, the other printer prints a surface grain in a registered mode, so that the grain may be matched with the pattern, and a relatively realistic surface texture is presented. However, the digital printers cannot make a very deep grain, and a depth of the grain generally ranges from 0.2 mm to 0.3 mm only. If gravure printing ink is used for making the grain, costs of ink and printing devices are too high.

### SUMMARY

The present disclosure aims to solve at least one of the technical problems in the prior art above. Therefore, the present disclosure provides a method for preparing a decorative material and application thereof, and the decorative material has a whole-body texture and a surface grain matched with a pattern, with a high fidelity, a low material cost and a low device cost.

According to an aspect of the present disclosure, a method for preparing a decorative material is provided, which includes the following steps of:
S1: using a main base material for material distribution to form a main base material layer, and distributing a grain base material on an upper surface of the main base material layer to form a grain pattern, so as to obtain a blank, wherein the main base material is a thermoplastic material;
S2: performing hot-press molding on the blank to obtain a semi-finished product embedded with the grain base material on a surface; and
S3: removing the grain base material on the surface of the semi-finished product to obtain the decorative material.

At a set temperature of the hot-press molding in the step S2, the grain base material and the main base material are non-fused.

In some implementations of the present disclosure, the removing in the step S3 is realized by brushing or sucking.

In some implementations of the present disclosure, the decorative material is a sheet material, in tiles or planks or a rollable material. The rollable material may be made, or the sheet material may be made according to a required dimension by continuous material distribution.

In some implementations of the present disclosure, the texture is a marble grain or a wood grain.

In some implementations of the present disclosure, preparation materials of the main base material include a thermoplastic polymer and a filler. Further, the thermoplastic polymer is selected from one or more of PVC, PET, PP, epoxy resin or PE.

In some implementations of the present disclosure, preparation materials of the main base material further include a toner and/or a plasticizer. A ratio of the thermoplastic polymer to the filler is adjusted according to requirements, the plasticizer is added to further prepare into main base materials with different hardnesses, and formulations of different main base materials may be matched with toners with different colors. The main base materials with different hardnesses are used for material distribution according to a texture condition, a combination of the main base materials with different hardnesses may imitate naturally growing wood, in which there is a combination of softness and hardness, for example, a scar and an annual ring grain are relatively hard. Use of base materials with different formulations may achieve an effect of the combination of softness and hardness, and then different grains are scraped manually. Due to different hardnesses, there may be resistance during manual grain scraping, and different manual strengths may produce grains with different depths. Therefore, the combination of the base materials with different hardnesses may produce rich texture effects.

In some implementations of the present disclosure, the main base material is prepared by mixing raw materials, then granulating the mixture by extrusion or calendering, and crushing and sieving the granules.

In some implementations of the present disclosure, the main base material is one or more of granule, powder, flake or viscous substance. When the main base material is the viscous substance, a formulation of the main base material is preferably as follows: 50% to 82% of PVC powder, 15% to 40% of plasticizer and 3% to 10% of assistant by mass percent. The main base material of the viscous substance may be used for making a fine grain and a fine line, and may be discharged by a liquid distribution nozzle for layout, and the grain is outlined on a solid main base material. Further, the main base material of the viscous substance may be added with wear-resistant powder to improve wear resistance, such as aluminum oxide; and the main base material of the viscous substance may also be transparent.

In some implementations of the present disclosure, when the main base material is a solid, the main base material has a particle size of 15 meshes to 200 meshes.

In some implementations of the present disclosure, the filler is one of inorganic filler or natural plant fiber filler. The filler may be calcium carbonate or wood powder, plastic wood may be formed by adding the wood powder, and the wood grain contains wood components and aroma.

In some implementations of the present disclosure, the grain base material and the main base material are incompatible in characters, or have different melting temperatures or different hardnesses. Further, the grain base material is an inorganic solid material or a thermosetting plastic. A particle size of the grain base material is selected according to a roughness or a fineness of the grain. Further preferably, the grain base material is fine sand.

In some implementations of the present disclosure, a lower surface of the main base material layer is provided with a base layer. The decorative material may be made into a semi-body transparent texture or a whole-body transparent texture, when the decorative material is the semi-body transparent texture, the main base material in the step S1 is spread on the base layer, the base layer is a monochromatic base, material distribution is performed on the monochromatic base, and then the monochromatic base and the main base material are subjected to hot-press molding together in the step S2. An upper portion of the formed decorative material has a whole-body texture, and a lower portion of the formed decorative material is monochromatic, wherein the monochromatic base is made of a monochromatic sheet, tile or plank material or a monochromatic rollable material, and the material of the monochromatic base may be the same as or different from that of the base material, such as a PVC sheet and a main base material containing PVC, a PP sheet and a main base material containing PP, a PET sheet and a main base material containing PET, a PET sheet and a main base material containing PETG, and a MDF sheet and wood powder; and the rollable material may be a non-woven fabric, a glass fiber fabric and a PVC rollable material. When the monochromatic base is made of the sheet material, a digital material distributor may be connected with a sheet material extrusion production line, the digital material distributor is arranged above the extruded sheet material, and the main base material may be continuously spread on the extruded sheet material. When the monochromatic base is made of the rollable material, two ends of the production line are respectively provided with an unwinding mechanism and a winding mechanism, or the digital material distributor is combined with a rollable material extrusion production line. When the decorative material has the whole-body texture, the main base material in the step S1 is directly distributed.

In some implementations of the present disclosure, the base layer is made of a recycled material. The base layer is formed by comprehensively spreading and paving the recycled material. An advantage of using the recycled material as the base layer is more environmental protection. Further, the recycled material may be pet or petg.

In some implementations of the present disclosure, the material distribution is performed by the digital material distributor, and the main base material is distributed in a material distribution frame.

In some implementations of the present disclosure, a molding device used for hot-press molding may be a steel belt calender, a roller calender, a hot press, a multi-layer press and a single-layer press. The blank enters the molding device directly or through carrying by a carrier, and a molding method includes hot pressing, double steel belt calendering, or spreading the main base material on a layer of base fabric and then calendering the same with a roller. After finishing material distribution, heating is also performed before the blank enters the steel belt calender or the roller calender.

In some implementations of the present disclosure, the step S3 further includes performing surface treatment on the surface of the semi-finished product from which the grain base material is removed.

In some implementations of the present disclosure, the surface treatment includes at least one of coating, 3D printing, laser engraving and waxing. Preferably, the coating refers to UV surface haze treatment. A printing material used in the 3D printing is the main base material. A convex grain may be stacked on a surface by the 3D printing to enrich surface texture effects. Finer concave grains may be made by the laser engraving to enrich surface qualities.

The present disclosure further provides an application of the decorative material obtained by the above method in floor decoration or wall decoration.

According to a preferred implementation of the present disclosure, the present disclosure at least has the following beneficial effects.

According to the present disclosure, the grain base material is distributed on the surface of the main base material to form the surface grain corresponding to the whole-body texture, and after hot-press molding and removal of the grain base material, the concave grain can be formed on the surface of the decorative material, and the grain is matched with the whole-body texture pattern. Compared with digital printing, the method can flexibly adjust the depth of the grain, and is suitable for making the marble grain or the wood grain, with high fidelity and low cost of materials used, and existing devices can be used for retrofitting, so the device cost is low. Since the decorative material of the present disclosure has the whole-body texture, a problem of wearing off of a pattern layer is avoided. Therefore, a wear-resistant layer can be omitted, so the material cost is reduced.

### BRIEF DESCRIPTION OF THE DRAWINGS

The present disclosure is further described hereinafter with reference to the drawings and the embodiments, where:

FIG. 1 is a real product image of a whole-body decorative sheet obtained in Embodiment 1 of the present disclosure; and

FIG. 2 is a side view of a semi-body decorative sheet obtained in Embodiment 2 of the present disclosure.

### DETAILED DESCRIPTION

The concept and the generated technical effect of the present disclosure are clearly and completely described hereinafter with reference to the embodiments to fully understand the objects, the features and the effects of the present disclosure. Obviously, the described embodiments are only some but not all of the embodiments of the present disclosure, and based on the embodiments of the present disclosure, other embodiments obtained by those skilled in the art without going through any creative work all belong to the scope of protection of the present disclosure.

### Embodiment 1

In the embodiment, a whole-body decorative sheet was prepared, and a specific process was as follows.

(1) Granulation: 18 parts of PP, 73 parts of calcium carbonate filler, 1 part of stabilizer, 7 parts of plasticizer and a proper amount of toner were mixed by weight, and the mixture was extruded, granulated, crushed and sieved to obtain a main base material with a particle size of 15 meshes to 200 meshes.

(2) Digital material distribution: a design pattern to be made was introduced into a control computer of a digital material distributor, the main base material was distributed in a material distribution frame to form a main base material layer with a certain thickness, and then fine sand was spread on a corresponding place on an upper surface of the main base material layer according to a preset surface grain to obtain a blank.

(3) Hot-press molding: the material distribution frame was pushed into a multi-layer press, and the blank was subjected to hot-press molding, which was heated at 185° C. for 16 minutes first, then hot-pressed for 40 minutes under a pressure of 50 tons, and cooled for 20 minutes under a pressure of 50 tons finally, so as to obtain a semi-finished product embedded with the fine sand on a surface.

(4) Sand removal and surface treatment: the semi-finished product was taken out, the fine sand on the surface of the semi-finished product was removed by brushing, then the surface was sanded and coated with UV paint for haze treatment, and finally, the semi-finished product was cut and grooved to obtain the whole-body decorative sheet.

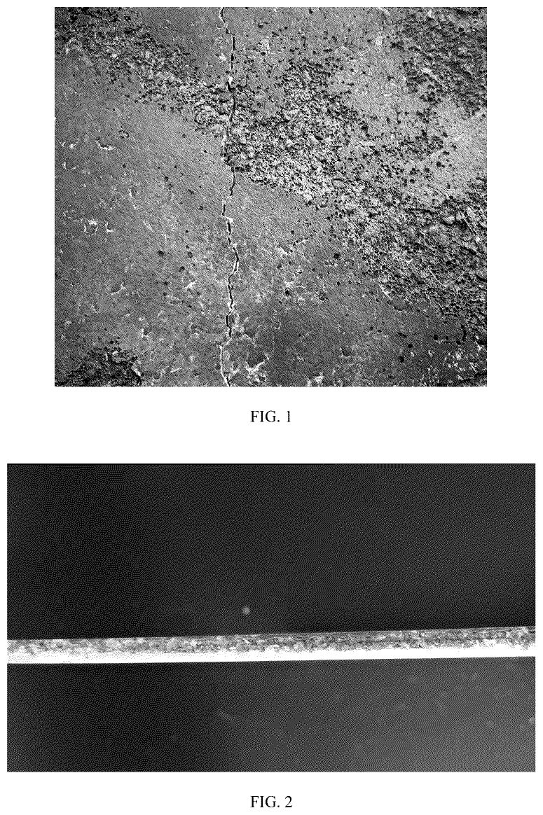

FIG. 1 is a real product image of the whole-body decorative sheet obtained in the embodiment. It can be seen from the drawing that a surface of a sheet material has a concave texture, and the texture is formed after removing the fine sand by brushing.

Performance test of whole-body decorative sheet in Embodiment 1

| Test item | Test method | | Unit | Standard | | Result |
|---|---|---|---|---|---|---|
| Total thickness | EN428 | | mm | +0.13-0.1 | mm | 5 mm |
| Density | EN436 | | kg/m³ | — | | 1746 |
| Static bending | GB 17657 | | Mpa | >=22 | | 27.9-20.7 |
| intensity | | | | | | |
| Elasticity modulus | GB 17657 | | Mpa | >=3500 <= 8000 | | 3197-4573 |
| Dimensional | iso23999 | L | % | <=0.15 | | 0.01 |
| stability 80° C. 6 hr | | W | % | <=0.15 | | 0.09 |
| | | Crimpness | mm | <=1 | | 0.4 |
| Residual | ASTM1914 | | % | <=3% | | 1.35 |
| indentation | | | | | | |

| Impact resistance | Big ball | mm | >=1600 | | 1700 |
|---|---|---|---|---|---|
| | Small ball | N | >=20 | n | 25 |

### Embodiment 2

In the embodiment, a semi-body decorative sheet was prepared, and a specific process was as follows.

(1) Granulation: 13 parts of PET, 70 parts of calcium carbonate filler, 9 parts of talcum powder, 1 part of stabilizer, 4 parts of plasticizer and a proper amount of toner were mixed by weight, and the mixture was extruded, granulated, crushed and sieved to obtain a main base material with a particle size of 15 meshes to 200 meshes.

(2) Digital material distribution: a digital material distributor was connected with a sheet material extrusion production line, and a monochromatic PVC sheet produced by the sheet material extrusion production line was used as a base layer. The digital material distributor distributes the main base material on the monochromatic PVC sheet, and then fine sand was spread on a corresponding place on an upper surface of a main base material layer according to a preset surface grain to obtain a blank consisting of the monochromatic PVC sheet, the main base material and the fine sand.

(3) Hot-press molding: a material distribution frame was pushed into a multi-layer press, and the blank was subjected to hot-press molding, which was heated at 140° C. for 16 minutes first, then hot-pressed for 30 minutes under a pressure of 20 tons, and cooled for 10 minutes under a pressure of 20 tons finally, so as to obtain a semi-finished product which had an upper portion with a whole-body texture and a monochromatic lower portion, and was embedded with the fine sand on a surface.

(4) Sand removal and surface treatment: the semi-finished product was taken out, the fine sand on the surface of the semi-finished product was removed by brushing, then the surface was sanded, subjected to 3D printing, and stacked with a convex grain, wherein a used printing material was the main base material, and finally, the semi-finished product was cut and grooved to obtain the semi-body decorative sheet.

FIG. 2 is a side view of the semi-body decorative sheet obtained in the embodiment. It can be seen from the drawing that a sheet material has an upper portion with a whole-body texture and a monochromatic lower portion.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure. In addition, the embodiments of the present disclosure and the features in the embodiments may be combined with each other without conflict.

1. A method for preparing a decorative material, comprising the following steps of:
S1: using a main base material for material distribution to form a main base material layer, and distributing a grain base material on an upper surface of the main base material layer to form a grain pattern, so as to obtain a blank, wherein the main base material is a thermoplastic material;
S2: performing hot-press molding on the blank to obtain a semi-finished product embedded with the grain base material on a surface; and
S3: removing the grain base material on the surface of the semi-finished product to obtain the decorative material.

2. The method according to claim 1, wherein the decorative material is a sheet material or a rollable material.

3. The method according to claim 1, wherein preparation materials of the main base material comprise a thermoplastic polymer and a filler.

4. The method according to claim 1, wherein preparation materials of the main base material further comprise a toner and/or a plasticizer.

5. The method according to claim 1, wherein the main base material is one or more of granule, powder, flake or viscous substance.

6. The method according to claim 1, wherein the grain base material and the main base material are incompatible in characters, or have different melting temperatures or different hardnesses.

7. The method according to claim 1, wherein a lower surface of the main base material layer is provided with a base layer.

8. The method according to claim 1, wherein the step S3 further comprises performing surface treatment on the surface of the semi-finished product from which the grain base material is removed.

9. The method according to claim 8, wherein the surface treatment comprises at least one of coating, 3D printing, laser engraving and waxing.

10. The method according to claim 1, wherein the decorative material is a floor decorative material or a wall decorative material.
